(19) United States
(12) Patent Application Publication
(10) Pub. No.: US 2020/0091812 A1
(43) Pub. Date: Mar. 19, 2020

(54) SEMICONDUCTOR DEVICE

(71) Applicant: Mitsubishi Electric Corporation, Tokyo (JP)

(72) Inventors: Takashi TSUBAKIDANI, Tokyo (JP); Shinji SAKAI, Tokyo (JP)

(73) Assignee: Mitsubishi Electric Corporation, Tokyo (JP)

(21) Appl. No.: 16/522,590

(22) Filed: Jul. 25, 2019

(30) Foreign Application Priority Data
Sep. 14, 2018 (JP) 2018-172038

(51) Int. Cl. H02M 1/08

(52) U.S. Cl. CPC H02M 1/08; H02M 5/4585

(57) ABSTRACT

A semiconductor device includes: parasitic inductances connected to respective power transistors; and a drive circuit connected to connection points at which the power transistors are connected to the respective parasitic inductances, and driving the power transistors. The drive circuit insulates reference potentials of the power transistors at the connection points from each other.

### BACKGROUND OF THE INVENTION

### Field of the Invention

The present invention relates to a semiconductor device, and, in particular, to a multi-phase converter.

### Description of the Background Art

Various techniques concerning semiconductor devices have been proposed. For example, Japanese Patent Application Laid-Open No. 2016-092988 proposes an inverter that can suppress a surge voltage.

In the conventional technology, however, application, to a gate of one phase, of a surge voltage of another phase cannot be suppressed in a multi-phase converter, and thus there is a concern that any malfunction may occur.

### SUMMARY

The present invention has been conceived in view of the above-mentioned problem, and it is an object of the present invention to provide technology for enabling suppression of the influence of a surge voltage in a multi-phase converter.

The present invention is a semiconductor device that includes: a plurality of semiconductor switching elements constituting a multi-phase converter, and corresponding to respective phases; a plurality of parasitic inductances connected to the respective semiconductor switching elements; and a drive circuit connected to a plurality of connection points at which the semiconductor switching elements are connected to the respective parasitic inductances, and driving the semiconductor switching elements. The drive circuit insulates reference potentials of the semiconductor switching elements at the connection points from one another.

The influence of the surge voltage in the multi-phase converter can be suppressed.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a circuit diagram illustrating a configuration of a first relevant semiconductor device.

FIG. 2 is a circuit diagram illustrating a configuration of a second relevant semiconductor device.

FIG. 3 is a circuit diagram illustrating one example of a circuit to which a semiconductor device according to Embodiment 1 is applied.

FIG. 4 is a circuit diagram illustrating a configuration of the semiconductor device according to Embodiment 1.

FIG. 5 is a circuit diagram illustrating a configuration of a semiconductor device according to Embodiment 2.

FIG. 6 is a circuit diagram illustrating a configuration of a semiconductor device according to a modification.

### DESCRIPTION OF THE PREFERRED EMBODIMENTS

### First and Second Relevant Semiconductor Devices

Prior to description of a semiconductor device according to Embodiment 1 of the present invention, first and second semiconductor devices relevant thereto (hereinafter, referred to as “first and second relevant semiconductor devices”) will be described first.

FIG. 1 is a circuit diagram illustrating a configuration of the first relevant semiconductor device, The first relevant semiconductor device in FIG. 1 includes a multi-phase converter. The first relevant semiconductor device controls, based on input signals from input terminals IN1 and IN2, AC voltages from terminals R and S connected to a commercial power supply to thereby generate desired DC voltages, and outputs the generated DC voltages from terminals P and N.

The first relevant semiconductor device in FIG. 1 includes a plurality of semiconductor switching elements (power transistors Q1 and Q2), a plurality of parasitic inductances (parasitic inductances L1 and L2), a plurality of diodes (diodes D1 and D2), and a drive circuit DR.

The power transistors Q1 and Q2 constitute a lower arm of the multi-phase converter, and correspond to respective phases. MOSFETs made, for example, of Si (silicon) are used as the power transistors Q1 and Q2. The number of power transistors is the same as the number of phases of the multi-phase converter, and is not limited to two, and may be three or more.

Respective drains of the power transistors Q1 and Q2 are connected to the terminals R and S. Sources of the power transistor's Q1 and Q2 are connected, through the parasitic inductances L1 and L2 of common wires, to a terminal N and a terminal GND of the drive circuit DR. A potential of the terminal GND corresponds to a ground potential,

Output terminals OUT1 and OUT2 of the drive circuit DR are connected to respective gates of the power transistors Q1 and Q2, and the drive circuit DR can drive the power transistors Q1 and Q2 so that the power transistors Q1 and Q2. are turned on and off based on the input signals from the input terminals IN1 and IN2. The drive circuit DR is supplied with power from a power supply Vcc for driving the power transistors Q1 and Q2. For example, a low voltage integrated circuit (LVIC) is used as the drive circuit DR.

The diodes D1 and D2 constitute an upper arm of the multi-phase converter. An anode of the diode D1 is connected to the terminal R and the drain of the power transistor Q1, and a cathode of the diode D1 is connected to the terminal P. An anode of the diode D2 is connected to the terminal S and the drain of the power transistor Q2, and a cathode of the diode D2 is connected to the terminal P.

With the above-mentioned configuration, when the power transistors Q1 and Q2 are driven (operated), the input signals are input into the input terminals IN1 and IN2 of the drive circuit DR, and, based on the input signals, the drive circuit DR charges and discharges the gates of the power transistors Q1 and Q2 through the output terminals OUT1 and OUT2. The gates are charged and discharged by a gate charge current flowing from the output terminals OUT1 and OUT2 to the terminal GND through the power transistors Q1 and Q2. In this case, due to the presence of the parasitic inductances L1 and L2 of the common wires on a path along which the gate charge current flows, an induced voltage is generated based on the parasitic inductances and a change (di/dt) in the gate charge current during driving. The induced voltage is thus applied, as the surge voltage, to the gates of the power transistors Q1 and Q2 at the time of charge and discharge of the gates. In contrast, the surge voltage can be suppressed in the second relevant semiconductor device, which will be described next.

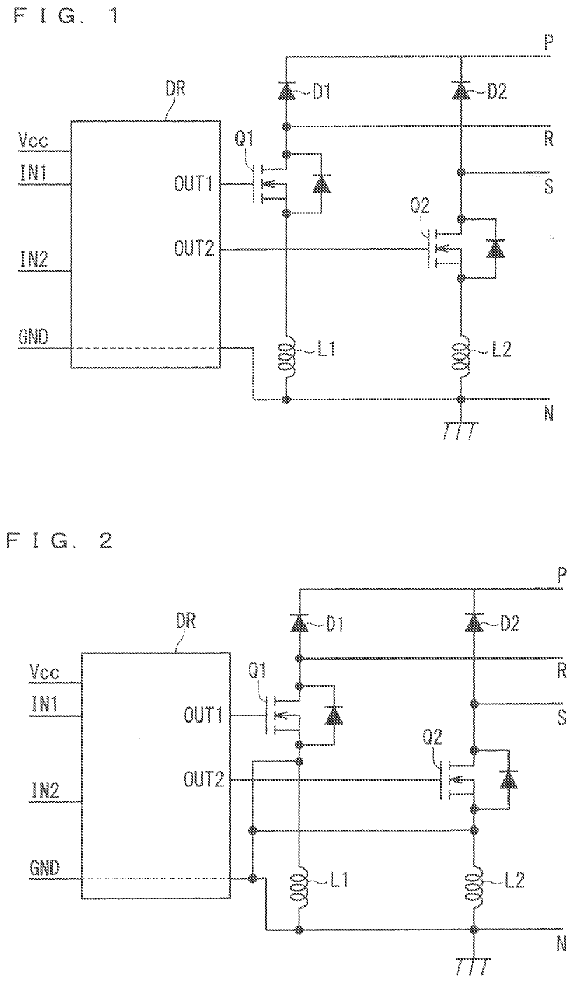

FIG. 2 is a circuit diagram illustrating a configuration of the second relevant semiconductor device. In the second relevant semiconductor device, the sources of the power transistors Q1 and Q2 are connected to the terminal GND of the drive circuit DR not through the parasitic inductances L1 and L2 of the common wires. Such a configuration can reduce the parasitic inductances, on the path along which the gate charge current flows. The induced voltage, that is, the surge voltage, applied to the gates of the power transistors Q1 and Q2 can thus be suppressed.

In the second relevant semiconductor device, however, reference voltages related to driving the gates of the respective phases are identical. Thus, in a multi-phase converter which has a multi-phase connection and in which a gate voltage further increases, the surge voltage of a power transistor of a driven phase is applied to the gate of a power transistor of an un-driven phase through the terminal. GND of the drive circuit DR collected proximate the source of the power transistor of each phase. As a result, an unnecessary voltage is applied to the gate of the power transistor of the un-driven phase, causing a concern about the occurrence of any malfunction. To suppress the influence of the surge voltage as described above, it is necessary to provide a power supply for applying a reverse bias to the gate or a filter circuit for suppressing the influence of the surge voltage. In contrast, the influence of the surge voltage in the multi-phase converter can be suppressed with a simple configuration in a semiconductor device according to Embodiment 1, which will be described next.

### Embodiment 1

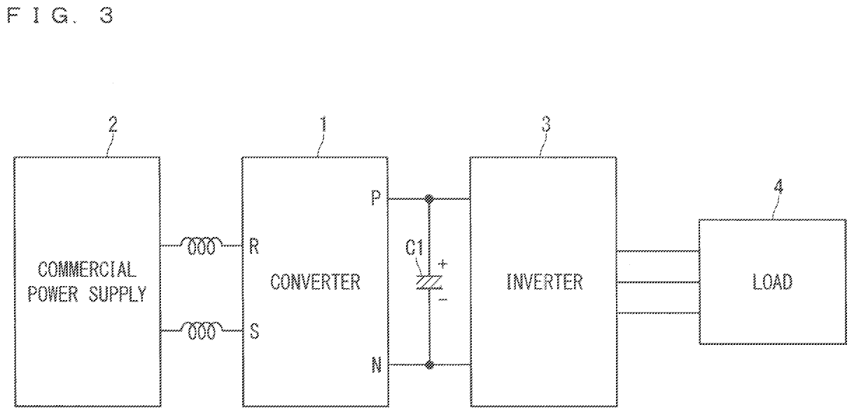

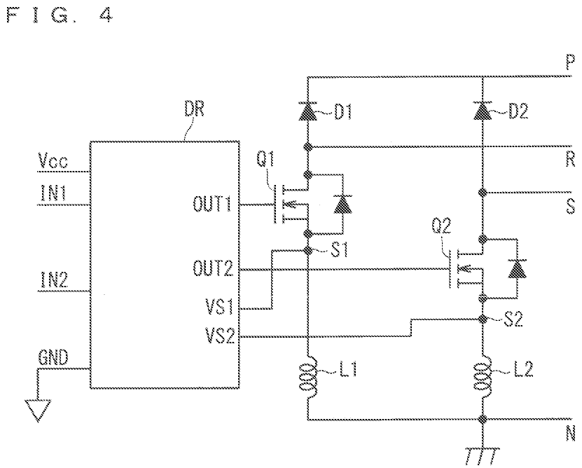

FIG. 3 is a circuit diagram illustrating one example of a circuit to which the semiconductor device according to Embodiment 1 is applied. Any components according to Embodiment 1 that are the same as or similar to the above-mentioned components hereinafter bear the same reference signs as those of the above-mentioned components, and components different from the above-mentioned components are mainly described.

The semiconductor device according to Embodiment 1 includes a converter 1, and, in particular, includes a multi-phase converter as with the first and second relevant semiconductor devices. The converter 1 converts an AC voltage from a commercial power supply 2 into a desired DC voltage, and outputs the DC voltage to an inverter 3 through a capacitor C1. The inverter 3 converts the input DC voltage into a desired AC voltage, and outputs the AC voltage to a load 4. FIG. 3 illustrates one example, and the semiconductor device according to Embodiment 1 may be applied to a circuit other than that illustrated in FIG. 3.

FIG. 4 is a circuit diagram illustrating a configuration of the semiconductor device according to Embodiment 1. As with the first and second relevant semiconductor devices, the semiconductor device according to Embodiment 1 controls, based on the input signals from the input terminals IN1 and IN2, the AC voltages from the terminals R end S connected to the commercial power supply to thereby generate the desired DC voltages, and outputs the generated DC voltages from the terminals P and N.

The power transistors Q1 and Q2, the parasitic inductances L1 and L2, and the diodes D1 and D2 are respectively similar to the power transistors Q1 and Q2, the parasitic inductances L1 and L2, and the diodes D1 and D2 of the first and second relevant semiconductor devices.

The drive circuit DR drives the power transistors Q1 and Q2 as in the first and second relevant semiconductor devices. For example, a high voltage integrated circuit (HVIC) or the LVIC is used as the drive circuit DR.

The drive circuit DR according to Embodiment 1 is connected to each of a connection point S1 at which the power transistor Q1 is connected to the parasitic inductance L1 and a connection point S2 at which the power transistor Q2 is connected to the parasitic inductance L2. In an example of FIG. 4, a terminal VS1 of the drive circuit DR is connected to the connection point S1 provided proximate the source of the power transistor Q1 without being connected to the connection point S2 provided proximate the source of the power transistor Q2. A terminal VS2 of the drive circuit DR is connected to the connection point S2 without being connected to the connection point S1.

The drive circuit DR according to Embodiment 1 insulates reference potentials of the power transistors Q1 and Q2 at a plurality of connection points (the connection points S1 and S2) from each other. The drive circuit DR herein includes a pn junction that insulates the reference potentials of the power transistors Q1 and Q2 from each other through junction isolation, and the terminals VS1 and VS2 and the terminals (OUT1 and OUT2) used for output to the gates of the respective phases are insulated from each other by the drive circuit DR.

### Operation

In a case where switching operation of the power transistor QI is performed, for example, the surge voltage is generated by the change (di/dt) in the gate charge current occurring in the power transistor Q1 and the parasitic inductance L1 as described above. In the semiconductor device according to Embodiment 1, the drive circuit DR insulates the reference potentials of the power transistors Q1 and Q2 from each other. This can interrupt the current between the terminals VS1 and VS2, and suppress the influence of the surge voltage generated during operation of the power transistor Q1 on the gate voltage of the power transistor Q2. As a result, an unnecessary variation in the gate voltage of the power transistor Q2 can be suppressed, and any malfunction occurring due to the variation can be suppressed.

### Summary of Embodiment 1

According to the semiconductor device according to Embodiment 1 as described above, the influence of the surge voltage of the power transistor of the driven phase on the power transistor of the un-driven phase can be suppressed, and thus any malfunction of the gate can be suppressed. The effect as described above can be achieved without providing the power supply for applying the reverse bias to the gate or the filter circuit for suppressing the influence of the surge voltage. Reduction in the number of power supplies, ease of circuit design, and, further, an increase in switching speed can thus be expected.

### Embodiment 2

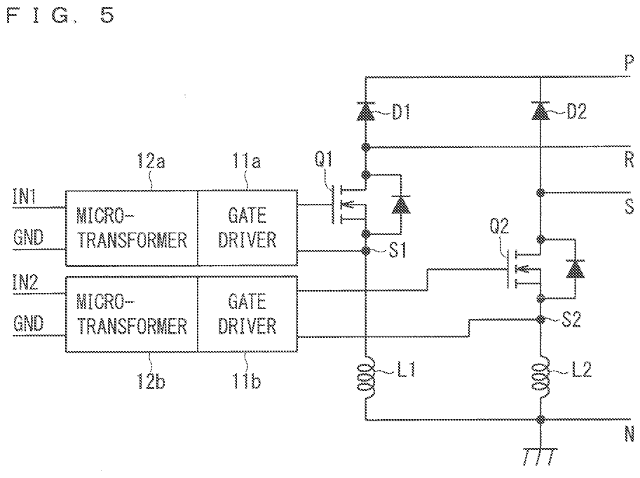

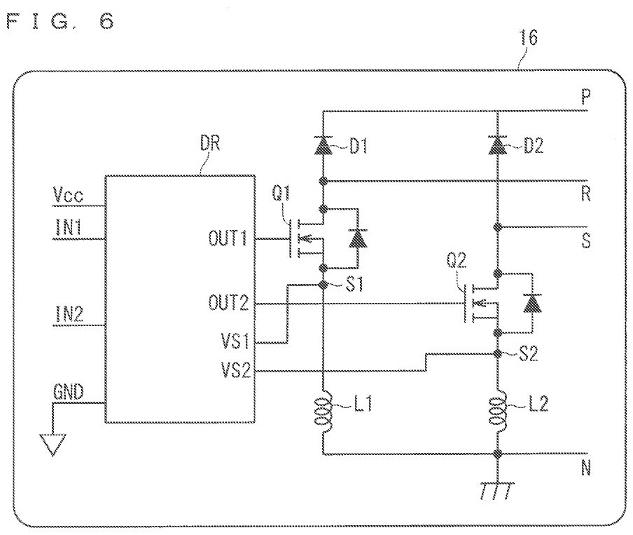

FIG. 5 is a circuit diagram illustrating a configuration of a semiconductor device according to Embodiment 2. Any components according to Embodiment 2 that are the same as or similar to the above-mentioned components hereinafter bear the same reference signs as those of the above-mentioned components, and components different from the above-mentioned components are mainly described.

The drive circuit DR according to Embodiment 1 includes the pn junction that insulates the reference potentials of the power transistors Q1 and Q2 from each other through junction isolation. In contrast, the drive circuit DR according to Embodiment 2 includes a plurality of gate drivers (gate drivers 11a and 11b) and a plurality of micro-transformers (micro-transformers 12a and 12b).

The gate drivers 11a and 11b are provided to correspond to the respective power transistors Q1 and Q2, and drive the respective gates of the power transistors Q1 and Q2. The micro-transformers 12a and 12b are provided to correspond to the respective power transistors Q1 and Q2, and supply the respective gate drivers 11a and 11 b with power while insulating the reference potentials of the power transistors Q1 and Q2 from each other.

According to the semiconductor device according to Embodiment 2 as described above, the effect similar to the effect achieved in Embodiment 1 can be achieved.

### Modification

FIG. 6 is a circuit diagram illustrating a configuration of a semiconductor device according to a modification of Embodiment 1. The semiconductor device in FIG. 6 includes a package 16 that covers the power transistors Q1 and Q2, the parasitic inductances L1 and L2, the diodes D1 and D2, and the drive circuit DR in Embodiment 1. With such a configuration, the effect similar to the effect achieved in Embodiment 1 can also be achieved. A similar package may be added in Embodiment 2, although it is not illustrated.

In Embodiments 1 and 2, the power transistors Q1 and Q2 are described to be made of S1 as in the first and second relevant semiconductor devices. The power transistors Q1 and Q2, however, may be formed of wide bandgap semiconductors that have a larger band gap compared with Si. The wide bandgap semiconductors include silicon carbide, gallium nitride-based materials, and diamond, for example. Such a configuration can increase the switching speed of the power transistors. The increase in switching speed leads to an increase in surge voltage, but the configuration in Embodiments 1 and 2 can suppress the influence of the surge voltage as described above. The configuration in Embodiments 1 and 2 thus facilitates application of the wide bandgap semiconductors.

Embodiments and modifications of the present invention can freely be combined with each other, and can be modified or omitted as appropriate within the scope of the invention.

While the invention has been shown and described in detail, the foregoing description is in all aspects illustrative and not restrictive. it is therefore understood that numerous modifications and variations can be devised without departing from the scope of the invention.

What is claimed is:

1. A semiconductor device comprising:
a plurality of semiconductor switching elements constituting a multi-phase converter, and corresponding to respective phases;
a plurality of parasitic inductances connected to the respective semiconductor switching elements; and
a drive circuit connected to each of a plurality of connection points at which the semiconductor switching elements are connected to the respective parasitic inductances, and driving the semiconductor switching elements, wherein
the drive circuit insulates reference potentials of the semiconductor switching elements at the connection points from one another.

2. The semiconductor device according to claim 1, wherein
the drive circuit includes a pn junction that insulates the reference potentials of the semiconductor switching elements from one another.

3. The semiconductor device according to claim 1, wherein
the drive circuit includes a plurality of micro-transformers that insulate the reference potentials of the semiconductor switching elements from one another.

4. The semiconductor device according to claim 1, further comprising
a package covering the semiconductor switching elements.

5. The semiconductor device according to claim 1, wherein
the semiconductor switching elements include wide bandgap semiconductors.
